(19) United States
(12) Patent Application Publication
(10) Pub. No.: US 2005/0185537 A1
(43) Pub. Date: Aug. 25, 2005

(54) Evaluation method, recording method, program and recording medium, and optical disk apparatus

(76) Inventor: Masaki Ninomiya, Kanagawa (JP)

Correspondence Address: DICKSTEIN SHAPIRO MORIN & OSHINSKY LLP, 2101 L Street, NW, Washington, DC, 20037, US

(21) Appl. No.: 11/037,080

(22) Filed: Jan. 19, 2005

(30) Foreign Application Priority Data
Jan. 20, 2004 (JP) NO. 2004-011920

(51) Int. Cl. G11B 7/09

(52) U.S. Cl. 369/44.33; 369/44.32; 369/47.14; 369/47.53

(57) ABSTRACT

An optical recording apparatus can maintain an excellent recording quality. A recording quality is evaluated when recording information on an optical disc Test recording is performed on a predetermined test area, when recording strategy information corresponding to the optical disc is unknown, based on default recording strategy information. The recording quality is evaluated by reproducing data recorded on the test area.

### BACKGROUND OF THE INVENTION

1. Field of the Invention

The present invention generally relates to optical recording techniques and, more particularly, to an optical recording technique for recording information on an optical disk using a pulsed laser light.

2. Description of the Related Art

In recent years, with advances in digital techniques and improvement in the data compression techniques, attention is drawn to optical discs as recording media for recording information (hereinafter, may be referred to as “contents”) regarding music, images and computer software. The optical discs includes, a compact disc (CD), a digital versatile disc (DVD) which is capable of recording data equivalent to seven times the CD with the same diameter as the CD. Thus, with reduction in their prices, optical disc apparatuses using such optical discs as recording media have become popular.

In the optical disc apparatus, a laser light is emitted by a light source and the laser light is projected through an object lens onto a recording surface of an optical disc, on which spiral or concentric tracks are formed, so as to form small spots on the recording surface to perform information recording or erasing or information reproducing based on a reflected light from the recording surface.

In the optical disc, information is recorded according to lengths of mark areas and space areas, which have different reflectance from each other, and combinations of those lengths. Thus, in the optical disc apparatus, when recording information on an optical disc, a power of a laser light emitted from a light source is controlled so that mark areas and space areas having target lengths are formed at target positions.

For example, in an optical disc, which has a recording surface containing organic dye and permits recording only one time, such as a CD-R (CD-Recordable), DVD-R (DVD-Recordable), DVD+R (DVD+Recordable), etc., when forming a mark area, a light-emitting power is increased so as to heat and defuse dye to transform and deform a disc base part contacting the dye part. On the other hand, when forming a space area, a light-emitting power is set as small as a power for reproduction so that disc base does not transform or deform. Thus, a reflectance of the mark area is lower than the space area.

On the other hand, in a rewritable optical disc, which has a recording surface containing a special alloy and, such as a CD-RW (CD-Rewritable), DVD-RW (DVD-Rewritable), DVD+RW (DVD+Rewritable), etc., when forming a mark area, the special alloy is rapidly cooled after being heated at a first temperature so as to set the special alloy in an amorphous state. On the other hand, when forming a space area, the special alloy is gradually cooled after being heated at a second temperature lower than the first temperature so as to set the special alloy in a crystal state. Thus, a reflectance of the mark area is lower than the space area. The temperature control of the special alloy can be achieved by controlling a light-emitting power of a laser light.

When forming a mark area, in order to eliminate influences of thermal storage, a light-emitting power is divided into a plurality of pulses (multi-pulse) such as disclosed in Japanese Laid-Open Patent Application No. 2002-334433. Such a control method of a light-emitting power is also referred to as a multi-pulse recording method.

In the multi-pulse recording method, the rule (method) of converting the light-emitting power into the multi-pulse is referred to as recording strategy. Since the light-emitting power gives great influences to a recording quality, it is very important to optimize the recording strategy. An optimum recording strategy changes according to a material of the above-mentioned organic dye or special alloy and a thickness of the disc board. Thus, generally, an optimum recording strategy depends on a manufacturer (bender) of an optical disc and a type of optical disc.

Thus, For example, Japanese Laid-Open Patent Application No. 2001-283443 discloses a technique to previously record on an optical disc a piece of information regarding recording characteristics of the optical disc. However, since optical parameters, such as a wave length of a laser light emitted by a light source and a numerical aperture (NA) of an object lens, and a raising time of a write pulse, or the like are different from an optical disc apparatus to an optical disc apparatus, there is a problem in that an optimum recording strategy cannot be obtained even from the information regarding recording characteristics recorded on an optical disc.

### SUMMARY OF THE INVENTION

It is a general object of the present invention to provide an improved and useful evaluation method and an optical disc apparatus in which the above-mentioned problems are eliminated.

A more specific object of the present invention is to provide an evaluation method and an optical recording apparatus which can maintain an excellent recording quality.

In order to achieve the above-mentioned invention, there is provided according to the present invention an evaluation method of evaluating a recording quality when recording information on an optical disc, comprising: a step of performing test recording on a predetermined test area, when recording strategy information corresponding to the optical disc is unknown, based on default recording strategy information; and a step of evaluating the recording quality by reproducing data recorded on the test area.

According to the above-mentioned invention, when the recording strategy information corresponding to the optical disc is unknown, the test recording is performed on a predetermined test area based on the default recording strategy information. Then, data recorded in the test area is reproduced, and the recording quality is evaluated based on a result of the reproduction. Thereby, it can be known as to whether or not the default recording strategy is appropriate for the optical disc prior to recording data in the designated recording area. Therefore, recording having a poor recording quality can be eliminated, which maintains an excellent recording quality.

In the evaluation method according to the present invention, the step of evaluating may evaluate the recording quality based on an error rate when the data recorded on the test area is reproduced. The step of evaluating may decrease, when reproducing data recorded on the test area, a level of an error correction capability to be lower than a normal level. The test area may be a test writing area. The test area may have a size corresponding to four ECC blocks defined on the optical disc. The step of evaluating may reproduce data in a second ECC block and a third ECC block among the four ECC blocks.

Additionally, there is provided according to another aspect of the present invention a recording method for recording information on an optical disc using a pulsed laser light, comprising: a step of performing test recording on a predetermined test area, when recording strategy information corresponding to the optical disc is unknown, based on default recording strategy information; a step of evaluating the recording quality by reproducing data recorded on the test area; and a step of deciding whether or not to permit recording on a designated recording area.

According to the above-mentioned invention, when the recording strategy information corresponding to the optical disc is unknown, the test recording is performed on a predetermined test area based on the default recording strategy information. Then, data recorded in the test area is reproduced, and the recording quality is evaluated based on a result of the reproduction, and thereafter it is decided whether to permit the recording on the designated recording area based on a result of evaluation. That is, when recording information on an optical disc of which recording strategy information is unknown, the test recording is performed prior to recording data in the designated recording area so as to decide whether to permit the recording on the designated recording area. Thus, recording having a poor recording quality can be eliminated, which results in an excellent recording quality being maintained.

The recording method according to the above-mentioned invention may further comprise a step of performing recording on the designated recording area when a decision is made to permit the recording in the step of deciding. The recording method according to the present invention may further comprise a step of judging whether or not the recording strategy information corresponding to the optical disc is unknown prior to the step of performing the test recording. In the recording method according to the present invention, the step of judging may search a table storing sets of recording strategy information for each kind of the optical disc so as to judge whether or not the recording strategy information corresponding to the optical disc is unknown. The recording method according to the present invention may further comprise a step of adding ID information of the optical disc and a result of decision in the step of deciding to the table by relating the ID information and the result of decision to each other. The recording method according to the present invention may further comprise a step of stopping the recording on the designated recording area, when a prohibition of the recording has been decided, by searching the table based on the ID information of the disc. The ID information may include at least one of a disc manufacture ID and a media type ID.

Additionally, there is provided according to another aspect of the present invention a program used by an optical disc apparatus for causing a control computer to perform: a procedure of performing test recording on a predetermined test area, when recording strategy information corresponding to the optical disc is unknown, based on default recording strategy information; a procedure of evaluating the recording quality by reproducing data recorded on the test area; and a procedure of deciding whether or not to permit recording on a designated recording area.

Accordingly, when the program according to the above-mentioned invention is loaded to a predetermined memory and a head address thereof is set to a program counter, the control computer of the optical disc apparatus performs when the recording strategy information corresponding to the optical disc is unknown, the test recording on a predetermined test area based on the default recording strategy information. Then, data recorded in the test area is reproduced, and the recording quality is evaluated based on a result of the reproduction, and thereafter it is decided whether to permit the recording on the designated recording area based on a result of evaluation. That is, the program according to the present invention causes the recording method according to the present invention, thereby enabling an excellent recording quality being maintained.

The program according to the present invention may further cause the control computer to perform a procedure of performing recording on the designated recording area when a decision is made to permit the recording in the procedure of deciding. The program according to the present invention may further cause the control computer to perform a procedure of judging whether or not the recording strategy information corresponding to the optical disc is unknown prior to the step of performing the test recording. The program according to the present invention may cause the control computer to perform a procedure of searching a table storing sets of recording strategy information for each kind of the optical disc so as to judge whether or not the recording strategy information corresponding to the optical disc is unknown. The program according to the present invention may further cause the control computer to perform a procedure of adding ID information of the optical disc and a result of decision in the procedure of deciding to the table by relating the ID information and the result of decision to each other. The program according to the present invention may further cause the control computer to perform a procedure of stopping the recording on the designated recording area, when a prohibition of the recording has been decided, by searching the table based on the ID information of the disc.

Additionally, there is provided according to another aspect of the present invention a computer readable recording medium storing the above-mentioned program.

Further, there is provided according to another aspect of the present invention an optical disc apparatus comprising: ID information acquiring means for acquiring ID information of an optical disc; judging means for judging whether or not recording strategy information corresponding to the optical disc is unknown based on the ID information; testing means for performing test recording on a predetermined test area, when the recording strategy information corresponding to the optical disc is unknown as a result of judgment, based on default recording strategy information; evaluating means for evaluating the recording quality by reproducing data recorded on the test area; and deciding means for deciding whether or not to permit recording on a designated recording area.

According to the above-mentioned invention, when recording information on the optical disc, the ID information of the optical disc is acquired by the ID information acquiring means, and it is judged whether or not the recording strategy information corresponding to the optical disc is unknown by the judging means based on the acquired ID information. As a result of judgment by the judging means, when the recording strategy information according to the optical disc is unknown, the test recording is performed on a predetermined test area based on the default recording strategy information by the testing means. Then, data in the test area is reproduced by the evaluating means and it is decided whether to permit the recording on the designated recording area by the deciding means based on the result of evaluation. That is, when recording information on the optical disc of which recording strategy information is unknown, the test recording is performed prior to recording on the designated recording area so as to decide whether to permit the recording on the designated recording area. Thus, recording having a poor recording quality can be eliminated, which results in an excellent recording quality being maintained.

In the optical disc apparatus according to the present invention, the evaluating means may evaluate the recording quality based on an error rate when data of the test are is reproduced. The evaluating means may decrease, when reproducing data recorded on the test area, a level of an error correction capability to be lower than a normal level. The test area may be a test writing area. The test area may have a size corresponding to four ECC blocks defined on the optical disc. The evaluating means may reproduce data in a second ECC block and a third ECC block among the four ECC blocks.

The optical disc apparatus according to the present invention may further comprise recording means for performing recording on the designated recording area when a permission of the recording is decided by the deciding means. In the optical disc apparatus according to the present invention, the evaluating means may search a table storing sets of recording strategy information for each kind of the optical disc so as to judge whether or not the recording strategy information corresponding to the optical disc is unknown.

The optical disc apparatus according to the present invention may further comprise adding means for adding ID information of the optical disc and a result of decision by the deciding means to the table by relating the ID information and the result of decision to each other. The optical disc apparatus according to the present invention may further comprise stopping means for stopping the recording on the designated recording area, when a prohibition of the recording has been decided, by searching the table based on the ID information of the disc. In the optical disc apparatus according to the present invention, the ID information may include at least one of a disc manufacture ID and a media type ID.

Other objects, features and advantages of the present invention will become more apparent from the following detailed description when read in conjunction with the accompanying drawings.

### BRIEF DESCRIPTION OF THE DRAWINGS

FIG. 1 is a block diagram of an optical disc apparatus according to an embodiment of the present invention;

FIG. 2 is a circuit diagram of a hold circuit shown in FIG. 1;

FIGS. 3A, 3B and 3C are waveform charts for explaining a β value;

FIG. 4A is a waveform chart for explaining recording strategy information;

FIG. 4B is an illustration for explaining table information representing the recording strategy information;

FIG. 5 is a flowchart of a recording process according to the embodiment of the present invention;

FIG. 6A is a graph showing a relationship between a time and a light-emitting power for explaining OPC; and

FIG. 6B is a graph showing a relationship between a β value and a light-emitting power for explaining OPC.

### DETAILED DESCRIPTION OF THE PREFERRED EMBODIMENTS

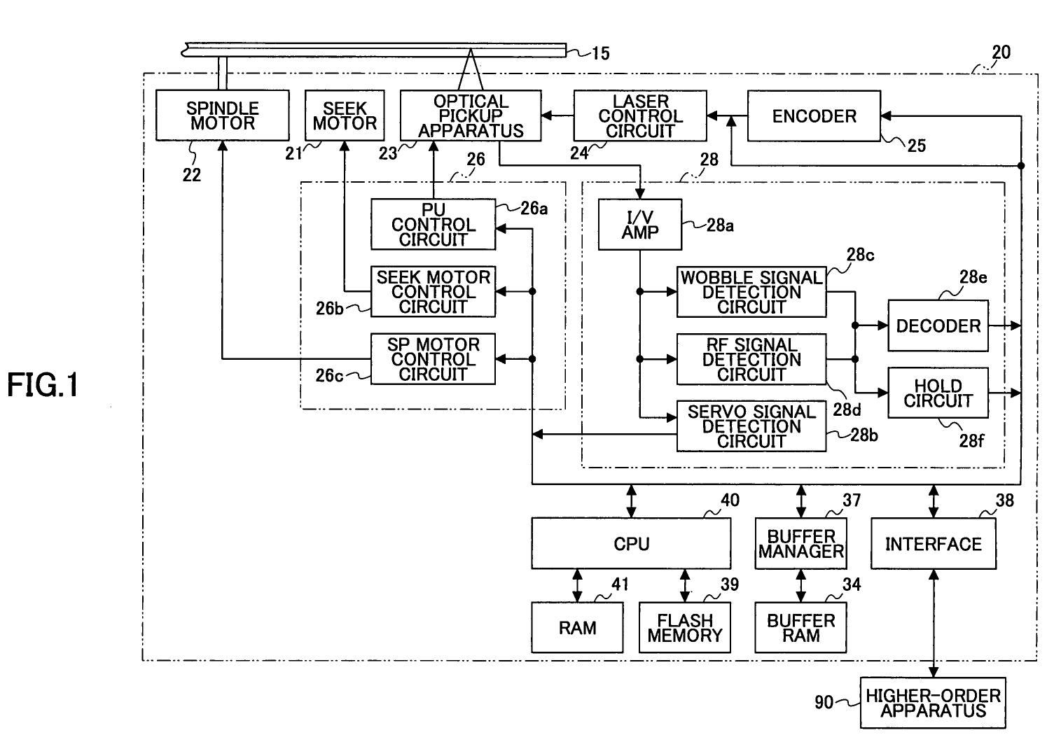

A description will now be given, with reference to FIG. 1, of an optical disc apparatus according to an embodiment of the present invention. FIG. 1 is a block diagram of the optical disc apparatus according to the embodiment of the present invention.

The optical disc apparatus 20 shown in FIG. 1 comprises: a spindle motor 22 for rotating an optical disc 15; an optical pickup apparatus 23; a seek motor 21 for moving the optical pickup apparatus 23; a laser control circuit 24; an encoder 25; a serve control circuit 26; a reproduction signal processing circuit 28; a buffer RAM 34; a buffer manager 37; an interface 38; a flash memory 39; a CPU 40; and a RAM 41. It should be noted that arrows in FIG. 1 indicate flows of typical signals and information, and does not indicate all connections of the blocks. Additionally, in the present embodiment, an information recording medium conforming to a standard of DVD+R is used for the optical disc 15. Further, it is assumed that user data from a higher order apparatus 90 is recorded according to a multi-pulse recording method.

The optical pickup apparatus 23 irradiates a laser light onto a recording surface of the optical disc 15 on which spiral or concentric tracks (recording area) are formed, and receives a reflected light from the recording surface. The optical pickup apparatus 23 comprises: a semiconductor laser as a light source; an object lens which guides a beam of light to the recording surface of the optical disc 15; an optical system which guides a returning beam of light reflected by the recording surface to a predetermined light-receiving position; a light-receiving element located at the predetermined light-receiving position to receive the returning beam of light; and drive system (a focusing actuator and a tracking actuator). A signal corresponding to a received amount of light is output from the light-receiving element to the reducing signal processing circuit 28.

The above-mentioned reproduction signal processing circuit 28 comprises an I/V amplifier 28a, a servo signal detection circuit 28b, a wobble signal detection circuit 28c, an RF signal detection circuit 28f, a decoder 28e, a hold circuit 28f, etc.

The I/V amplifier 28a converts an output signal of the light-receiving element constituting the optical pickup apparatus 23 into a voltage signal, and amplifies the signal with a predetermined gain.

The signal detection circuit 28b detects servo signals such as a focal error signal and a track error signal based on the output signal of the I/V amplifier 28a. The servo signal detected here is output to the above-mentioned servo control circuit 26.

The above-mentioned wobble signal detection circuit 28c detects a wobble signal based on the output signal of the I/V amplifier 28a. The above-mentioned RF signal detection circuit 28d detects an RF signal based on the output signal of the I/V amplifier 28a.

The above-mentioned decoder 28e extracts address information, a synchronization signal, etc., from the above-mentioned wobble signal. The address information extracted here is output to the CPU 40, and the synchronization signal is output to the encoder 25. Moreover, the decoder 28e performs a decoding process and an error detecting process on the RF signal, and, when an error is detected, the decoder 28e performs an error correction process and, thereafter, stores the RF data as reproduced data in the buffer RAM 34 through the buffer manager 37. It should be noted that error rate information detected by the error detection process is sent to the CPU 40.

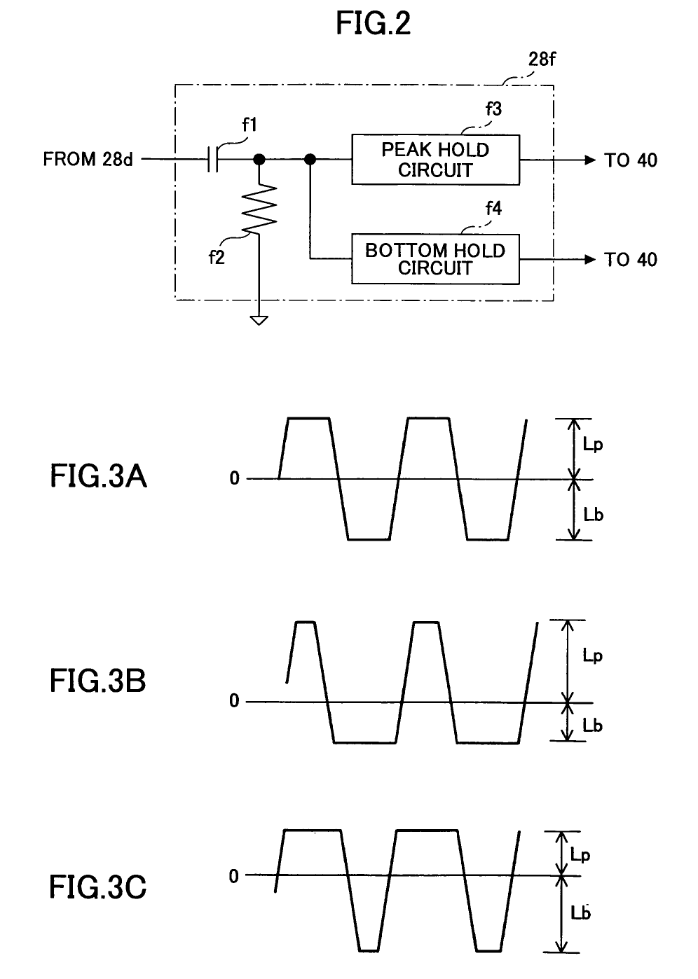

The hold circuit 28f detects an upper envelope level and a lower envelope level of the RF signal. Here, as shown in FIG. 2 as an example, the hold circuit has a capacitor f1 and a resistor f2 for AC-coupling the RF signal, a peak hold circuit f3 for detecting the upper envelope signal (referred to as Lp) of the RF signal after AC-coupled, and a bottom hold circuit f4 for detecting the lower envelope level (referred to as Lb). The detected upper envelope level Lp and the detected lower envelope level Lb are output to the CPU 40, respectively. Then, the CPU 40 computes a so-called β value based on the following equation (1).
β=(Lp−Lb)/(Lp+Lb) (1)

Here, the above-mentioned beta value is explained. When a record power is appropriate, as shown in FIG. 3A as an example, the upper envelope level Lp and the lower envelope level Lb are values close to each other. The beta value at this time is referred to as βtarget. In the present embodiment, as an example, it is set as βtarget=0.04 (4%). When a recording power is larger than an appropriate value, as shown in FIG. 3B as an example, the upper envelope level Lp becomes larger than the lower envelope level Lb, and the beta value becomes larger than βtarget. On the other hand, when a record power is smaller than an appropriate value, as shown in FIG. 3C as an example, the upper envelope level Lp becomes smaller than the lower envelope level Lb, and a beta value becomes small than βtarget.

Returning to FIG. 1, the above-mentioned servo control circuit 26 has a PU control circuit 26a, a seek motor control circuit 26b and an SP motor control circuit 26c.

In order to correct a focal error of an object lens, the PU control circuit 26a produces a drive signal for the focusing actuator based on the above-mentioned focal error signal, and outputs the drive signal to the optical pickup apparatus 23. Moreover, in order to correct a track error of the object lens, the PU control circuit 26a produces a drive signal for the tracking actuator based on the above-mentioned track error signal, and outputs the drive signal to the optical pickup apparatus 23. Thereby, the tracking control and focusing control are carried out.

The above-mentioned seeking motor control circuit 26b produces a drive signal for driving the seek motor 21 based on an instruction of the CPU 40, and output the drive signal to the seek motor 21.

The above-mentioned SP motor control circuit 26c produces a drive signal for driving the spindle motor 22 based on an instruction of the CPU 40, and outputs the drive signal to the spindle motor 22.

Data (data for recording) to be recorded on the optical disc 15 and data (data for reproduction) reproduced from the optical disc 15 are temporarily stored in the above-mentioned buffer RAM 34. Data input and output of the buffer RAM 34 are managed by the above-mentioned buffer manager 37.

The above-mentioned encoder 25 retrieves the data for recording stored in the buffer RAM 34 based on an instruction of the CPU 40, and performs data modulation and addition of an error correction code so as to produce a write signal to the optical disc 15. The thus-produced write signal is output to the laser control circuit 24.

The above-mentioned interface 38 is a bidirectional communication interface with a higher-order apparatus (for example, personal computer) 90, and is conform to a standard interfaces such as ATAPI (AT Attachment Packet Interface) and SCSI (Small Computer System Interface).

The above-mentioned flash memory 39 constituted to include a program area and a data area. Programs including a program (hereinafter, referred to as “recording process program”) which is described in a code readable by the CPU 40 is stored in the program area of the flash memory 39. Additionally, information regarding light-emitting characteristics of the semiconductor laser and recording strategy information are stored in the data area of the flash memory 39.

The CPU 40 controls operations of each part according to the above-mentioned program stored in the program area of a flash memory 39, and saves data required for the control in the RAM 41 and the buffer RAM 34.

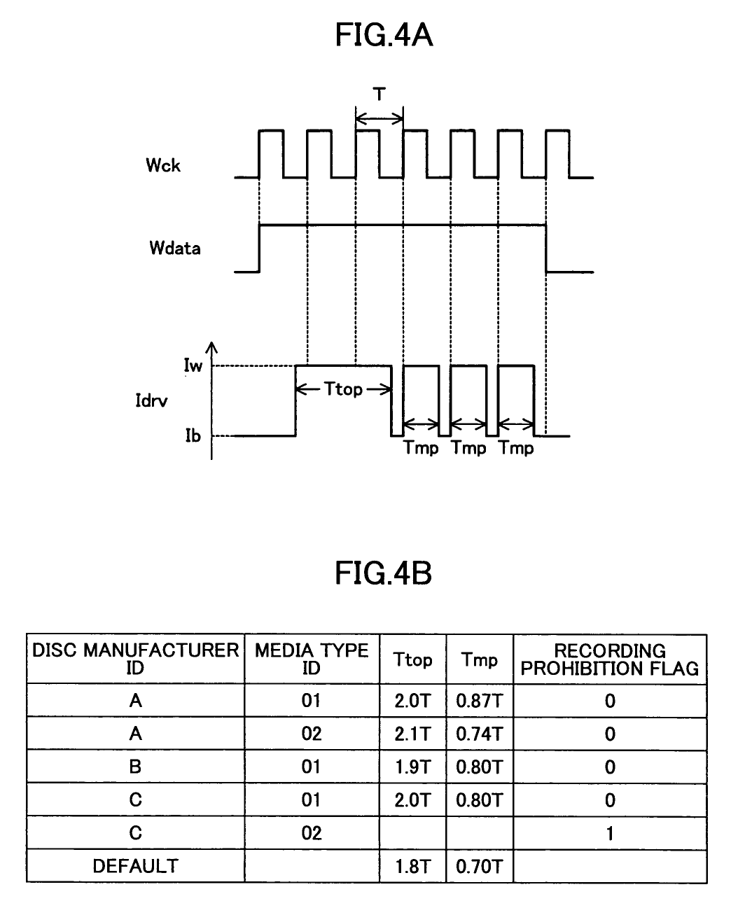

A description will now be given of the above-mentioned recording strategy information. The recording strategy information includes information regarding parameters that determine a pulse form configuration when changing a write signal into multi-pulse signal. For example, as shown in FIG. 4A, a pulse form configuration is determined by a pulse width (referred to as Ttop) of a head heating pulse in a drive signal Idrv of the semiconductor laser and a pulse width (referred to as Tmp) of an intermediate heating pulse and a final heating pulse that are produced based on the write signal Wdata. It should be noted that FIG. 4A shows a case where a length of the mark area formed on the recording surface is 6T (T is a period of a reference clock signal Wck (record channel clock signal)). Iw indicates a signal level corresponding to a recording power, and Ib indicates a signal level corresponding to a reproduction power.

In the present embodiment, as shown in FIG. 4B as an example, the recording strategy information is stored in the data area of the flash memory 39 in a table format (hereinafter, may be referred to as “strategy table”) in accordance with a disc manufacture ID and media type ID. For example, when the disc manufacturer ID is “A” and the media type ID is “01”, Ttop=2.0T and Tmp=0.87T. Additionally, Ttop=1.8T and Tmp=0.70T are set as default values.

Further, the recording prohibition flag is set to the above-mentioned strategy table. For example, when the disc manufacturer ID is “C” and the media type ID is “02”, the recording prohibition flag is “1”, which indicates that recording on the optical disc is prohibited. In addition, if a recording prohibition flag is “0”, it indicates that recording on the optical disc is not prohibited.

The recording strategy information is referred to by the CPU 40 when recording. Additionally, the recording strategy information is acquired at least one of manufacturing process, adjusting process and inspection process of the optical disc apparatus 20, and is stored in the data area of the flash memory 39.

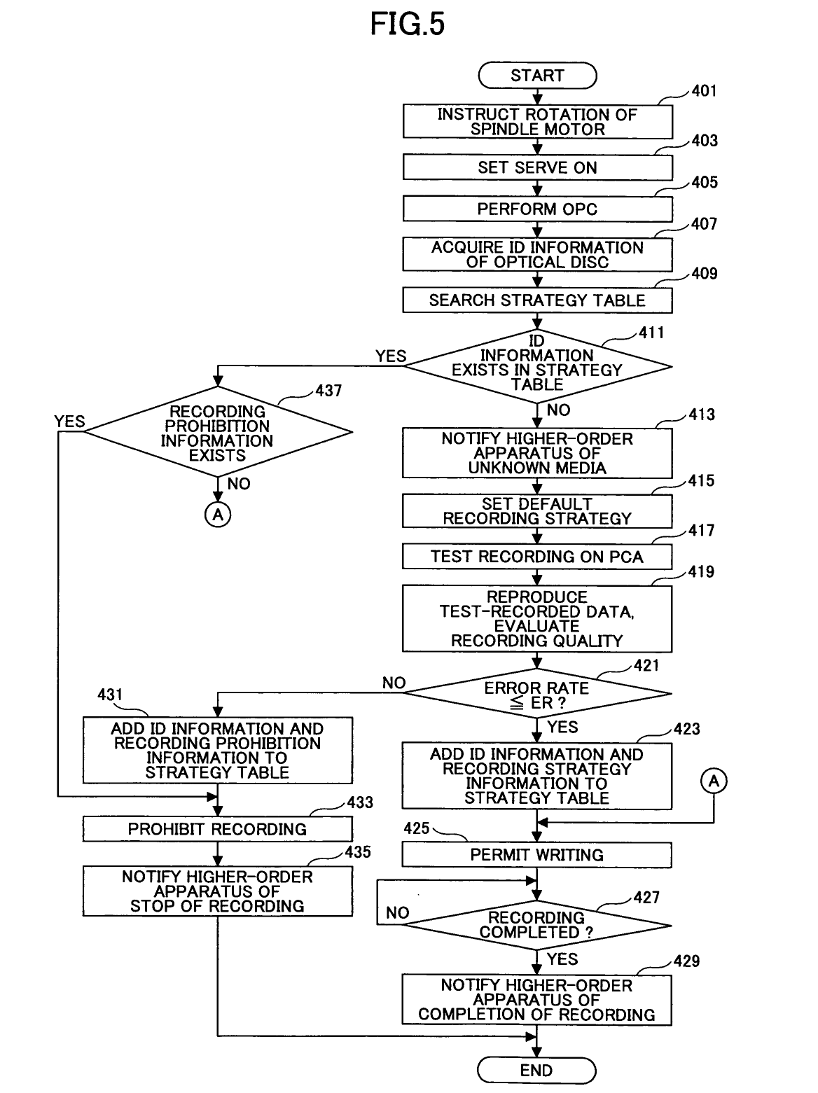

A description will now be given, with reference to FIG. 5, of a process (recording process) in the optical disc apparatus 20 when a recording request command is received from the higher-order apparatus 90. The flowchart of FIG. 5 corresponds to a process algorithm performed by the CPU 40. When a recording request command is received from the higher order apparatus 90, a head address of the program corresponding to the flowchart of FIG. 5 is set to a program counter of the CPU 40, and a recording process is started.

In the first step 401, an instruction is issued to the SP motor control circuit 26c so that the optical disc 15 rotates at a predetermined linear velocity (or angular velocity), and a notification that the recording request command was received from the higher order apparatus 90 is sent to the reproduction signal processing circuit 28. Additionally, an instruction to accumulate the data (data for recording) received from the higher-order apparatus 90 in the buffer RAM 34 is sent to the buffer manager 37.

In the subsequent step 403, after confirming that the optical disc 15 is rotating at a predetermined linear velocity (or angular velocity), a servo-on is set to the servo control circuit 26. Thereby, a tracking control and a focusing control are performed as mentioned above. It should be noted that the tracking control and the focusing control are performed as needed until the recording process is completed.

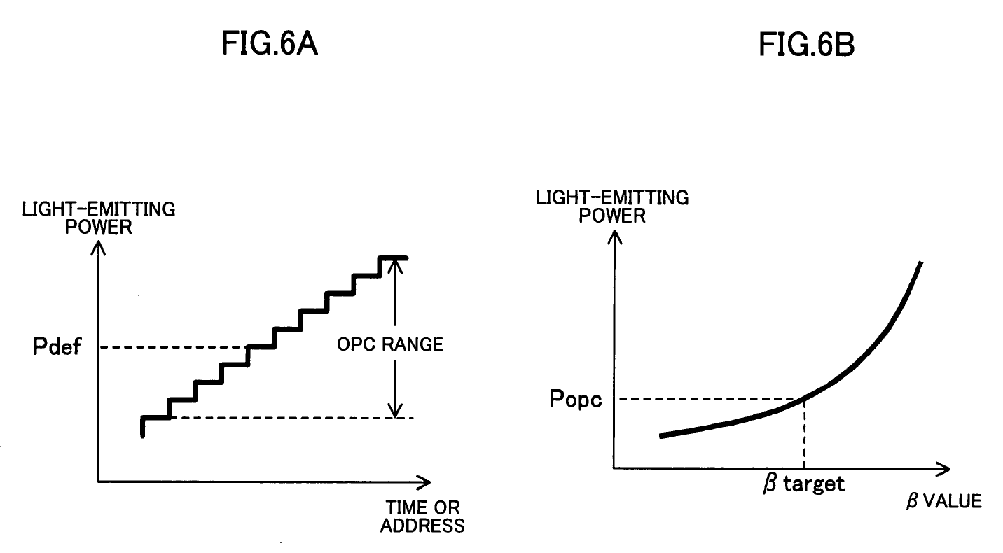

In the subsequent step 405, an OPC (optimum power control) is performed so as to acquire an optimal recording power. That is, a test write of predetermined data is performed on a test write area referred to as a PCA (power calibration area) while changing the light-emitting power step by step. The PCA is provided in each of an inner periphery and an outer periphery of the optical disc 15. In the present embodiment, as shown in FIG. 6A as an example, a range (OPC range) of +40% of a power of a reference power (referred to as Pdef) and a −30% power of the reference power Pdef is mostly made into ten phases at equal intervals. It should be noted that a range between (Pdef+5 mW) and (Pdef−4 mW) may be changed by a step of 2 mW. Then, a test write area is sequentially reproduced so as to compute the above-mentioned β value for each light-emitting power. Then, as shown in FIG. 6B as an example, the approximation (for example, a secondary equation) showing a relationship between a light-emitting power and a β value is acquired, and a light-emitting power corresponding to the above-mentioned βtarget is acquired so as to set the acquired light-emitting power as an appropriate recording power.

Returning to FIG. 5, in the subsequent step 407, ID information of the optical disc 15 is acquired. Here, a disc manufacture ID and a media type ID contained in ADIP (address in pregroove) information are acquired.

In the subsequent step 409, the above-mentioned strategy table is searched using the disc manufacture ID and the media type and ID as a key. Then, in step 411, it is determined whether or not there is ID information which matches the strategy table as a result of the search in the above-mentioned step 409. If there is no matched ID information, the determination is negative, and the routine proceeds to step S413. In step 413, a notification is sent to the higher-order apparatus 90 that the optical disc 15 is an unknown medium.

In the subsequent step 415, recording strategy information set as default is extracted from the strategy table, and is sent to the laser control circuit 24 together with optimum recording power information acquired by the OPC. In the subsequent step 417, a test recording is performed on the PCA. Here, as an example, a predetermined test data is written in four ECC blocks as an example.

In the subsequent step 419, data recorded by the test recording is reproduced and an error rate is measure so as to evaluate a recording quality. Here, as an example, the test data written in the second and third ECC blocks among the 4ECC blocks is reproduced. Additionally, a level of an error correction capability when reproducing the test data is made lower than usual. For example, usually, when double correction is being performed, an error rate is measured by rendering it as a single correction. It should be noted that the first ECC block is not rendered to be a reproduction area since the RF signal is not in a steady state in the first ECC block. Further, since the fourth ECC block is a boundary area with an area used by OPC, unexpected writing may have been made, and, thus, the fourth ECC block is not rendered to be a reproduction area.

In the subsequent step 421, it is determined whether or not the error rate from the decoder 28e is equal to or smaller than a previously set value ER (for example, 1000). For example, if the error rate exceeds ER, the determination is negative, and the routine proceeds to step 431. It should be noted that the value of ER can be set by a user through the higher-order apparatus 90.

In step 431, the ID information and the recording prohibition information are added to the strategy table. Here, the disc manufacture ID and the media type ID of the optical disc 15 are added, and “1” is set to the recording prohibition flag. In the subsequent step 433, prohibition of recording on the optical disc 15 is effected. In the subsequent step 435, a notification is sent to the higher-order apparatus 90 that recording cannot be performed on the optical disc 15. Then, the recording process is ended.

It should be noted that, if the error rate is equal to or smaller than ER in the above-mentioned step 421, the determination of step 421 is affirmative, and the routine proceeds to step 423. In step 423, the ID information and the recording strategy information are added to the strategy table. Here, the data of the disc manufacture ID and the media type ID of the optical disc 15 is added, and default recording strategy information is copied as the recording strategy thereof. Additionally, “0” is set to the recording prohibition flag.

In the subsequent step 425, a permission of writing is given to the encoder 25. Accordingly, data from the higher-order apparatus 90 is recorded on a designated recording area of the optical disc 15 through the encoder 25, the laser control circuit 24 and the optical pickup apparatus 23. In the subsequent step 427, it is determined whether or not the recording has been completed. If not completed, a waiting state is set. Then, after the completion of the recording, the determination becomes affirmative, and the routine proceeds to step 429. In the step 429, a notification that the recording has been completed is sent to the higher-order apparatus 90. Then, the recording process is ended.

On the other hand, if it is determined, in step 411, that there exists ID information which matches the strategy table, that is, if the determination of step 411 is affirmative, the routine proceeds to step 437. In the step 437, it is determined whether or not the recording on the optical disc 15 is prohibited by referring to the recording prohibition flag. If the recording prohibition flag is “0”, the determination is negative, and the routine proceeds to step 425. That is, recording on a designated recording area is performed.

On the other hand, if the recording prohibition flag is “1”, the determination of recording prohibition flag is affirmative, and the routine proceeds to the above-mentioned step 433. That is, recording on a designated recording area is not performed.

As appreciated from the above explanation, in the optical disk apparatus 20 according to the present embodiment, ID information acquiring means, judging means, test recording means, evaluating means determining means adding means and stopping means are achieved by the CPU 40 and the programs performed by the CPU 40. That is, the ID information acquiring means is achieved by the process of step 407 of FIG. 5, the judging means is achieved by the process of step 411, and the test recording means is achieved by the process of step 417. Moreover, the evaluating means is achieved by the process of step 419, the determining means is achieved by the process of step 421, the adding means is achieved by the process of steps 423 and 431, and the stopping means is achieved by the process of step 433. Further, the recording means is achieved by the optical pickup apparatus 23, the laser control circuit 24 and the encoder 25.

It should be noted that at least a part of the means achieved by the process according to the program executed by the CPU 40 may be constituted by hardware, or all means may be constituted by hardware.

Additionally, in the present embodiment, the program corresponding to the flowchart of FIG. 5 among programs stored in the program area of the flash memory 39 constitutes the above-mentioned recording process program. That is, the process of step 417 corresponds to the procedure of performing the test recording, the process of step 419 corresponds to the procedure of evaluating, the process of step 421 corresponds to procedure of determining, and the process of step 425 corresponds to the procedure of recording on a designated recording area. Additionally, the process of steps 409 and 411 corresponds to the procedure of judging, the process of steps 423 and 431 corresponds to the procedure of adding, and the process of step 433 corresponds to the procedure of stopping.

Furthermore, in the present embodiment, the evaluation method and recording method relating to the present invention are performed in the above-mentioned recording process. That is, a step of performing test recording in the evaluation method according to the present invention is performed by the process of step 417 of FIG. 5, and a step of evaluating is performed by the process of step 419. Additionally, a step of performing test recording in the recording method according to the present invention is performed by the process of step 417 in FIG. 5, a step of evaluating is performed by the process of step 419, a process of deciding is performed by the step of 421, and a step of recording on a designated recording area is performed by the process of step 425. Further, a step of judging is performed by the process of steps 409 and 411, a step of adding is performed by the process of steps 423 and 431, and a step of stopping is performed by the process of step 433.

As mentioned above, according to the optical disc apparatus 20 according to the present embodiment, upon receipt of the recording request command from the host 90, the disc manufacture ID and the media type and ID are acquired as ID information regarding the optical disc 15. Then, the strategy table is searched using the disc manufacture ID and the media type and ID as a key, and it is judged whether or not there is ID information which matches the key. Here, if there is no matched ID information, it is judged that the optical disc 15 concerned is an unknown medium, and the test recording is performed on the PCA in accordance with the default recording strategy information extracted from the strategy table. Then, the test-recorded data is reproduced so as to measure an error rate, and it is judged whether of not the error rate is equal to or smaller than the previously set value ER. Then, if the error rate is equal to or smaller than ER, recording on a designated recording area is permitted. On the other hand, if the error rate exceeds ER, recording on the designated recording area is prohibited. That is, when recording strategy information records information on an unknown optical disc, test recording is performed on a test write area before recording on a designated recording area, and the recording on the designate recording area is performed after it is confirmed that a predetermined recording quality is acquired. Thus, a recording quality can be maintained at or higher than a predetermined level, which eliminates recording of a poor recording quality. Therefore, it is possible to maintain an excellent recording quality according to the present invention.

Moreover, since the ID information and a result of the test recording are added to the strategy table, there is no need to perform test recording when the same type optical disc is set thereafter. Therefore, the test area can be used effectively.

It should be noted that although the case of ER being equal to 1000 was explained in the above-mentioned embodiment, the present invention is not limited to such a value of ER. For example, if ER is set to a smaller value, a higher recording quality can be acquired.

Moreover, although an error rate if used for evaluating the recording quality of the test recording in the present embodiment, the present invention is not limited to the use of the error rate, and, for example, a jitter or a signal amplitude of the RF signal may be used.

Moreover, although it was explained in the above-mentioned embodiment about the case where test recording is performed on four ECC blocks, the present invention is not limited to the number of ECC blocks. Moreover, although the second and third ECC blocks among the four ECC blocks are reproduced, respectively, in the above-mentioned embodiment, the present invention is not limited to such a reproduction as long as a reproduction can be performed.

Moreover, although the level of the error correction capacity is decreased when reproducing the test data in the above-mentioned embodiment, a normal error correction capability may be used depending on a desired recording quality.

Moreover, although the case where test recording is performed on the PCA was explained in the above-mentioned embodiment, the present invention is not limited to the test recording performed on the PCA and an area other than the PCA may be used.

Moreover, although it was explained about the case where the disc manufacture ID and the media type and ID are used as ID information of an optical disc, if it is possible to specify an optical disc, for example, either one of the disc manufacture ID and the media type and ID may be used solely.

Moreover, although the recording process program is recorded on a program area of the flash memory 39 in the above-mentioned embodiment, the recording process program may be recorded on other recording media such as a CD-ROM, a magneto-optical disc, a memory card, a USB memory, a flexible disk, etc. In such a case, the recording process program is loaded to the program area of the flash memory 39 through a reproducing apparatus (or an exclusive interface) corresponding to each recording medium. Moreover, the recording process program may be transferred to the program area of the flash memory 39 through a network (a LAN, an intranet, the Internet, etc.). That is, any methods may be used which can load the recording process program to the program area of the flash memory 39.

Moreover, although it was explained about the case where the optical disc apparatus handles a disc which conforms to a standard of DVD+R, the present invention is not limited to such a disc, and, for example, a DVD+RW, a CD-RW or a next generation information recording medium corresponding to a light having a wavelength of about 405 nm may be used.

Moreover, although it was explained about the case where the optical pickup apparatus has a single semiconductor laser in the above-mentioned embodiment, the present invention is not limited to the single semiconductor laser and a plurality of semiconductor lasers emitting laser lights having different wavelengths may be provided. In such a case, at least one of a semiconductor laser emitting a laser light having a wavelength of about 405 nm, a semiconductor laser emitting a laser light having a wavelength of about 660 nm, and a semiconductor laser emitting a laser light having a wavelength about 780 nm may be used. That is, the optical disc apparatus may correspond to a plurality of kinds of optical discs conforming to difference standards.

The present invention is not limited to the specifically disclosed embodiments, and variations and modifications may be made without departing from the scope of the present invention.

The present application is based on Japanese priority application No. 2004-011920 filed Jan. 20, 2004, the entire contents of which are hereby incorporated herein by reference.

1. An evaluation method of evaluating a recording quality when recording information on an optical disc, comprising:
a step of performing test recording on a predetermined test area, when recording strategy information corresponding to the optical disc is unknown, based on default recording strategy information; and
a step of evaluating the recording quality by reproducing data recorded on the test area.

2. The evaluation method as claimed in claim 1, wherein said step of evaluating evaluates the recording quality based on an error rate when the data recorded on said test area is reproduced.

3. The evaluation method as claimed in claim 1, wherein said step of evaluating decreases, when reproducing data recorded on said test area, a level of an error correction capability to be lower than a normal level.

4. The evaluation method as claimed in claim 1, wherein said test area is a test writing area.

5. The evaluation method as claimed in claim 1, wherein said test area has a size corresponding to four ECC blocks defined on the optical disc.

6. The evaluation method as claimed in claim 5, wherein said step of evaluating reproduces data in a second ECC block and a third ECC block among the four ECC blocks.

7. A recording method for recording information on an optical disc using a pulsed laser light, comprising:
a step of performing test recording on a predetermined test area, when recording strategy information corresponding to the optical disc is unknown, based on default recording strategy information;
a step of evaluating the recording quality by reproducing data recorded on said test area; and
a step of deciding whether or not to permit recording on a designated recording area.

8. The recording method as claimed in claim 7, further comprising a step of performing recording on said designated recording area when a decision is made to permit the recording in the step of deciding.

9. The recording method as claimed in claim 7, further comprising a step of judging whether or not the recording strategy information corresponding to said optical disc is unknown prior to the step of performing the test recording.

10. The recording method as claimed in claim 9, wherein the step of judging searches a table storing sets of recording strategy information for each kind of the optical disc so as to judge whether or not the recording strategy information corresponding to said optical disc is unknown.

11. The recording method as claimed in claim 10, further comprising a step of adding ID information of said optical disc and a result of decision in said step of deciding to said table by relating the ID information and the result of decision to each other.

12. The recording method as claimed in claim 11, further comprising a step of stopping the recording on said designated recording area, when a prohibition of the recording has been decided, by searching said table based on the ID information of said disc.

13. The recording method as claimed in claim 10, wherein said ID information includes at least one of a disc manufacture ID and a media type ID.

14. A program used by an optical disc apparatus for causing a control computer to perform:
a procedure of performing test recording on a predetermined test area, when recording strategy information corresponding to the optical disc is unknown, based on default recording strategy information;
a procedure of evaluating the recording quality by reproducing data recorded on said test area; and
a procedure of deciding whether or not to permit recording on a designated recording area.

15. The program as claimed in claim 14, further causing said control computer to perform a procedure of performing recording on said designated recording area when a decision is made to permit the recording in the procedure of deciding.

16. The program as claimed in claim 14, further causing said control computer to perform a procedure of judging whether or not the recording strategy information corresponding to said optical disc is unknown prior to the step of performing the test recording.

17. The program as claimed in claim 16, causing said control computer to perform a procedure of searching a table storing sets of recording strategy information for each kind of the optical disc so as to judge whether or not the recording strategy information corresponding to said optical disc is unknown.

18. The program as claimed in claim 17, further causing said control computer to perform a procedure of adding ID information of said optical disc and a result of decision in said procedure of deciding to said table by relating the ID information and the result of decision to each other.

19. The program as claimed in claim 18, further causing said control computer to perform a procedure of stopping the recording on said designated recording area, when a prohibition of the recording has been decided, by searching said table based on the ID information of said disc.

20. A computer readable recording medium storing a program used by an optical disc apparatus for causing a control computer to perform:
a procedure of performing test recording on a predetermined test area, when recording strategy information corresponding to the optical disc is unknown, based on default recording strategy information;
a procedure of evaluating the recording quality by reproducing data recorded on said test area; and
a procedure of deciding whether or not to permit recording on a designated recording area.

21. The computer readable recording medium as claimed in claim 20, where in the program further causing said control computer to perform a procedure of performing recording on said designated recording area when a decision is made to permit the recording in the procedure of deciding.

22. The computer readable recording medium as claimed in claim 20, where in the program further causing said control computer to perform a procedure of judging whether or not the recording strategy information corresponding to said optical disc is unknown prior to the step of performing the test recording.

23. The computer readable recording medium as claimed in claim 22, where in the program further causing said control computer to perform a procedure of searching a table storing sets of recording strategy information for each kind of the optical disc so as to judge whether or not the recording strategy information corresponding to said optical disc is unknown.

24. The computer readable recording medium as claimed in claim 23, where in the program further causing said control computer to perform a procedure of adding ID information of said optical disc and a result of decision in said procedure of deciding to said table by relating the ID information and the result of decision to each other.

25. The computer readable recording medium as claimed in claim 24, where in the program further causing said control computer to perform a procedure of stopping the recording on said designated recording area, when a prohibition of the recording has been decided, by searching said table based on the ID information of said disc.

26. An optical disc apparatus comprising:
ID information acquiring means for acquiring ID information of an optical disc;
judging means for judging whether or not recording strategy information corresponding to said optical disc is unknown based on the ID information;
testing means for performing test recording on a predetermined test area, when the recording strategy information corresponding to the optical disc is unknown as a result of judgment, based on default recording strategy information;
evaluating means for evaluating the recording quality by reproducing data recorded on said test area; and
deciding means for deciding whether or not to permit recording on a designated recording area.

27. The optical disc apparatus as claimed in acclaim 26, wherein said evaluating means evaluates the recording quality based on an error rate when data of said test are is reproduced.

28. The optical disc apparatus as claimed in claim 26, wherein said evaluating means decreases, when reproducing data recorded on said test area, a level of an error correction capability to be lower than a normal level.

29. The optical disc apparatus as claimed in claim 26, wherein said test area is a test writing area.

30. The optical disc apparatus as claimed in claim 26, wherein said test area has a size corresponding to four ECC blocks defined on the optical disc.

31. The optical disc apparatus as claimed in claim 30, wherein said evaluating means reproduces data in a second ECC block and a third ECC block among the four ECC blocks.

32. The optical disc apparatus as claimed in claim 26, further comprising recording means for performing recording on said designated recording area when a permission of the recording is decided by said deciding means.

33. The optical disc apparatus as claimed in claim 26, wherein said evaluating means searches a table storing sets of recording strategy information for each kind of the optical disc so as to judge whether or not the recording strategy information corresponding to said optical disc is unknown.

34. The optical disc apparatus as claimed in claim 33, further comprising adding means for adding ID information of said optical disc and a result of decision by said deciding means to said table by relating the ID information and the result of decision to each other.

35. The optical disc apparatus as claimed in claim 34, further comprising stopping means for stopping the recording on said designated recording area, when a prohibition of the recording has been decided, by searching said table based on the ID information of said disc.

36. The optical disc apparatus as claimed in claim 26, wherein said ID information includes at least one of a disc manufacture ID and a media type ID.
